(19) United States
(12) Patent Application Publication
(10) Pub. No.: US 2026/0043933 A1
(43) Pub. Date: Feb. 12, 2026

(54) THREE-DIMENSIONAL RESISTIVITY RESERVOIR MAPPING

(71) Applicant: Schlumberger Technology Corporation, Sugar Land, TX (US)

(72) Inventors: Mauro VIANDANTE, Sugar Lnad, TX (US); Jean-Michel DENICHOU, Stavanger (NO); Yazil ABBAS, Tananger (NO)

(21) Appl. No.: 19/139,894

(22) PCT Filed: Apr. 26, 2024
(86) PCT No.: PCT/US2024/026516

§ 371 Date: Jun. 17, 2025

Related U.S. Application Data
(60) Provisional application No. 63/499,092, filed on Apr. 28, 2023.

(51) Int. Cl. G01V 3/38; G01V 3/20

(52) U.S. Cl. CPC G01V 3/38; G01V 3/20

(57) ABSTRACT

A method for three-dimensional (3D) reservoir mapping includes obtaining a 3D resistivity volume in pointset format and transforming the 3D resistivity volume in pointset format to a 3D resistivity map in Society for Geological Exploration (SEG-Y) format. A method for identifying an interface between a high resistivity volume and a low resistivity volume may further include applying a first resistivity threshold to the 3D resistivity map in the SEG-Y format to generate a binary resistivity volume in which cells in the 3D resistivity map having a resistivity value greater than the first resistivity threshold are assigned a first high resistivity value and cells having a resistivity value less than the first resistivity threshold are assigned a second low resistivity value; and evaluating the binary resistivity volume to identify the interface between the high resistivity volume and the low resistivity volume.

### CROSS REFERENCE TO RELATED APPLICATIONS

This application claims the benefit of U.S. Provisional Application No. 63/499,092, entitled “THREE-DIMENSIONAL RESISTIVITY RESERVOIR MAPPING” filed Apr. 28, 2023, the disclosure of which is hereby incorporated herein by reference.

### BACKGROUND

Subsurface reservoirs are commonly mapped to promote development of an oilfield, for example, to determine optimal well placement and to compute oilfield reserves. Reservoir mapping has historically relied on expert interpretation of seismic data and various logging data obtained from test wells and production wells. During production, well placement may rely, at least in part, on reservoir maps and the placement of boundary layers within those maps to enable the well to be drilled through oil and gas bearing formations.

Ultradeep azimuthal resistivity (UDAR) measurements may be used in reservoir mapping while drilling (RMWD) operations. In such operations the resistivity environment around a wellbore may be mapped by making deep or ultradeep electromagnetic logging measurements in the wellbore. The depth of detection of such measurements is generally a function of the transmitter receiver spacing and the electromagnetic frequency used in the measurement (with large transmitter receiver spacings and low frequencies giving the greatest depth of detection). The electromagnetic measurements may be inverted using a one-dimensional (1D) longitudinal resistivity inversion (along the axis of the tool) and a two-dimensional (2D) transverse resistivity inversion (perpendicular to the axis of the tool). The inversions may then be used to create a three-dimensional (3D) resistivity volume or map about the wellbore.

While the above-described 3D resistivity volume provides a wealth of information about the subsurface formations penetrated by the wellbore, interpretation of this information is not straight forward. One of the main challenges in interpreting a 3D resistivity volume is to correlate it with existing seismic maps including seismic data and the corresponding seismic interpretations, inversions, attributes, etc. It is further difficult to update or modify the seismic maps the 3D resistivity volume. This correlation with and updating of the seismic maps can be of significant importance for making educated, proactive geosteering decisions in real-time during a drilling operation and for improving the field understanding for further development and oilfield planning. There is a need in the industry for improved RMWD methods that provide for improved integration with existing seismic maps.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts an example drilling rig including a deep reading electromagnetic logging while drilling tool.

FIG. 2 depicts an example deep reading electromagnetic logging while drilling tool.

FIG. 3 depicts a flow chart of one example method for generating a 3D resistivity map in SEG-Y format and identifying at least one horizon in the formation.

FIG. 4 depicts a flow chart of one example method for generating a 3D resistivity map in Society of Exploration Geophysics (SEG-Y) format.

FIG. 5 depicts a flow chart of another example method for generating a 3D resistivity map in SEG-Y format and identifying at least one horizon in the formation.

FIG. 6 depicts flow chart of one example method for extracting resistivity amplitudes from pointset data.

FIGS. 7A, 7B, 7C, and 7D (collectively FIG. 7) depict an example implementation of the method shown on FIG. FIG. 5 in which FIG. 7A depicts a 3D resistivity volume in pointset format, FIG. 7B depicts a 3D resistivity map in SEG-Y format, FIG. 7C depicts a binary volume, and FIG. 7D depicts a horizon derived from the binary volume.

### DETAILED DESCRIPTION

A method for three-dimensional (3D) reservoir mapping is disclosed. The method may include obtaining a 3D resistivity volume in pointset format and transforming the 3D resistivity volume in pointset format to a 3D resistivity map in Society for Geological Exploration (SEG-Y) format. A method for identifying an interface between a high resistivity volume and a low resistivity volume may further include applying a first resistivity threshold to the 3D resistivity map in the SEG-Y format to generate a binary resistivity volume in which cells in the 3D resistivity map having a resistivity value greater than the first resistivity threshold are assigned a first high resistivity value and cells having a resistivity value less than the first resistivity threshold are assigned a second low resistivity value; and evaluating the binary resistivity volume to identify the interface between the high resistivity volume and the low resistivity volume.

The disclosed embodiments may advantageously provide a 3D inverted resistivity volume in SEG-Y format from deep reading resistivity measurements and may further enable resistivity contrasts indicative of reservoir boundaries in the 3D volume to be readily identified and mapped. Moreover, the disclosed techniques may advantageously be utilized during a drilling operation and may update reservoir boundary locations while drilling proceeds. Moreover, it will be appreciated that the disclosed embodiments may advantageously enable petrophysicists to make use of well-established seismic tools to evaluate and interpret inverted resistivity data.

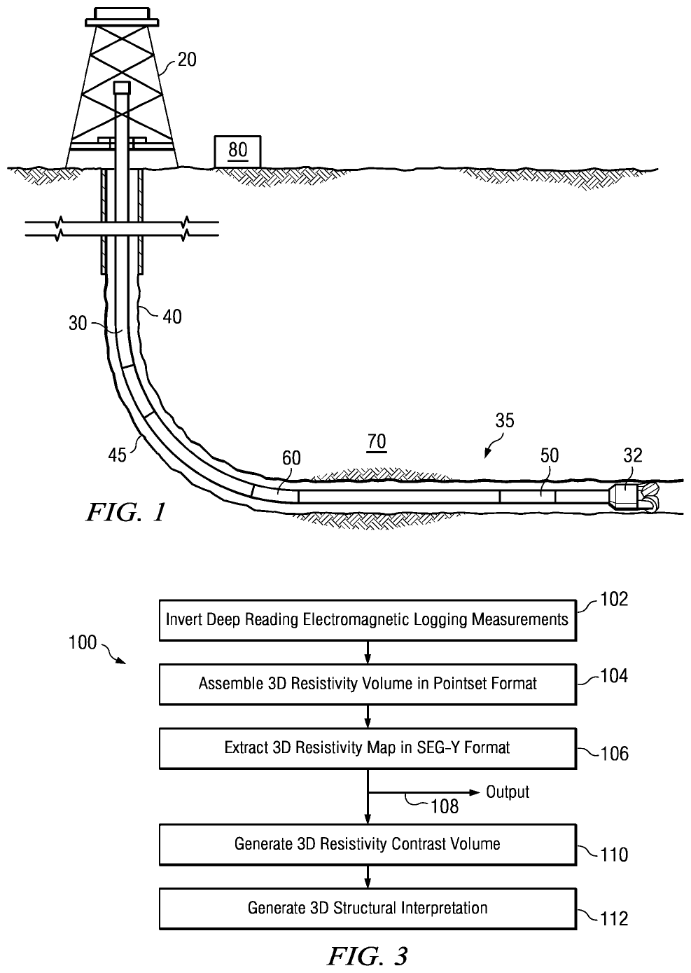

FIG. 1 depicts an example drilling rig 20 positioned over an oil or gas formation 70. The drilling rig may include a derrick and a hoisting apparatus (not shown) for raising and lowering a drill string 30, which, as shown, extends into wellbore 40 and includes a drill bit 32 deployed at the lower end of a bottom hole assembly (BHA) 35. In the depicted embodiment, the drill string 30 further includes a deep reading electromagnetic logging tool including distinct transmitter 50 and receiver 60 subs configured to make deep, directional, electromagnetic logging measurements in the wellbore 40 (e.g., of formation 70 which is penetrated by the wellbore).

It will be understood that the deployment illustrated on FIG. 1 is merely an example. Drill string 30 may include substantially any suitable downhole tool components, for example, including a steering tool such as a rotary steerable tool, a downhole telemetry system, and one or more additional MWD and/or LWD tools including various sensors for sensing downhole characteristics of the borehole and the surrounding formation. The disclosed embodiments are by no means limited to any particular drill string configuration.

It will be further understood that the disclosed embodiments are not limited to use with a land rig 20 as illustrated on FIG. 1 but may be equally well suited for use with either onshore or offshore operations. Moreover, disclosed embodiments are not limited to logging while drilling embodiments as illustrated on FIG. 1. The disclosed embodiments are equally well suited for use with any deep reading electromagnetic logging tool, including wireline logging tools and logging while drilling tools.

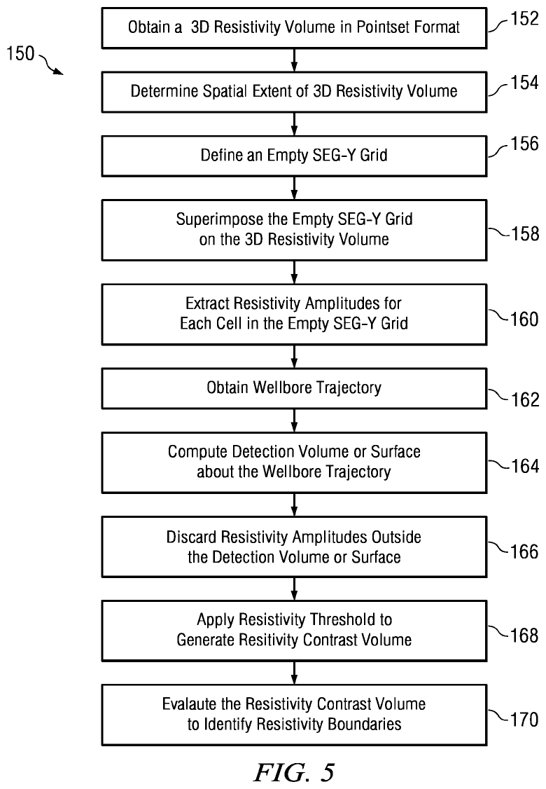

With further reference to FIG. 1, drilling rig 20 may further include an onsite operations or oilfield evaluation facility 80 (e.g., a control room or a field office). In the depicted embodiment, the operations facility may include a system for processing deep reading electromagnetic logging data, for example, including a computer or computer system. The computer system may include one or more processors (e.g., microprocessors) which may be connected to one or more data storage devices (e.g., hard drives or solid-state memory) and user interfaces as well as to cloud-based storage or additional processors. It will be further understood that the disclosed embodiments may include processor executable instructions stored in the data storage device. The executable instructions may be configured, for example, to execute methods 100, 120, and 150 which are described in more detail below with respect to FIGS. 3-5. As such, the computer system may be configured to invert electromagnetic logging data to generate a 3D resistivity volume, extract a 3D resistivity map in SEG-Y format from the 3D resistivity volume, and evaluate the 3D resistivity map to identify and/or characterize horizons, faults, fluid contacts, interfaces, and the like therein. It will of course be understood that the disclosed embodiments are not limited to the use of any particular computer hardware and/or software.

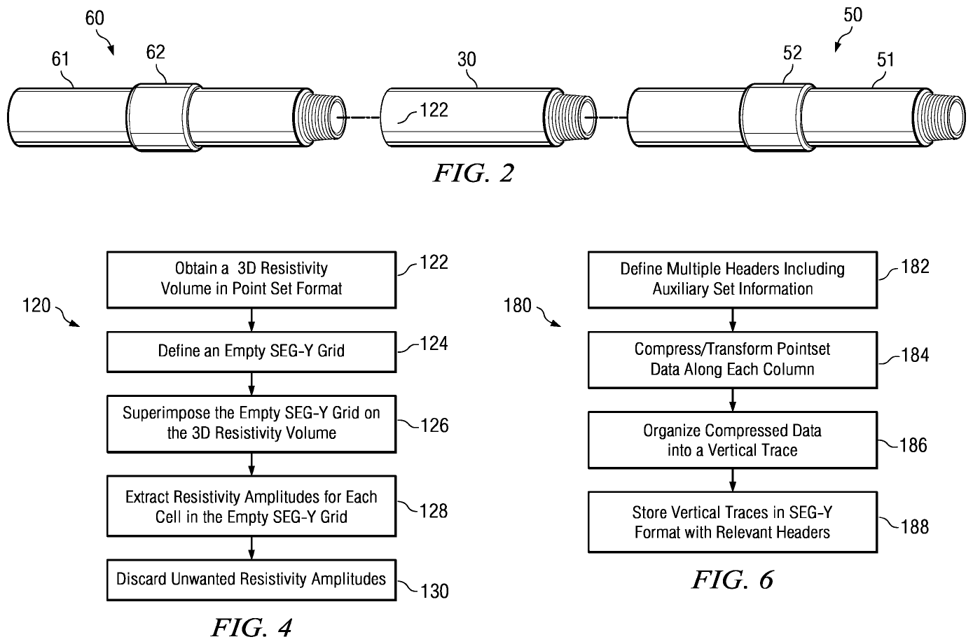

FIG. 2 depicts an example embodiment of a deep reading electromagnetic logging tool including distinct transmitter and receiver subs 50 and 60. In the example embodiment depicted, the transmitter sub (or tool) 50 includes at least one electromagnetic transmitter 52 (including one or more transmitting antennas) deployed on a transmitter collar 51. The receiver sub (or tool) 60 includes at least one electromagnetic receiver 62 (including one or more transmitting antennas) deployed on a receiver collar 61. When deployed in a drill string (e.g., drill string 30), the transmitter and receiver subs 50 and 60 may be axially spaced apart substantially any suitable distance to achieve a desired measurement depth (e.g., in a range from about 10 to about 50 meters or more depending on the measurement objectives). While not shown, one or more other BHA tools may be deployed between subs 50 and 60.

With continued reference to FIG. 2, the transmitter 52 and receiver 62 may each include substantially any suitable antenna configuration, for example, including tri-axial antennas (e.g., an axial antenna and first and second transverse antennas that are orthogonal to one another) or one or more tilted antennas. As is known to those of ordinary skill in the art, an axial antenna is one whose moment is substantially parallel with the longitudinal axis of the tool. A transverse antenna is one whose moment is substantially perpendicular to the longitudinal axis of the tool. A tilted antenna is one whose moment is angled with respect to the tool axis (e.g., at an angle of about 45 degrees). Such antenna configurations are well known and commonly used in the industry.

Deep reading electromagnetic measurements may be made in a wellbore (e.g., wellbore 40) by firing a transmitting antenna and measuring the voltage response in one or more receiving antennas. As is also known to those of ordinary skill, a time varying electric current (an alternating current) in a transmitting antenna (obtained by firing the antenna) produces a corresponding time varying magnetic field in the local environment (e.g., the tool collar and the formation). The magnetic field in turn induces electrical currents (eddy currents) in the conductive formation. These eddy currents further produce secondary magnetic fields which may produce a voltage response in a receiving antenna. The measured voltage in the receiving antennae can be processed, as is known to those of ordinary skill in the art, to obtain one or more properties of the formation (such as a formation resistivity).

The electromagnetic voltage measurements (or ratios of various voltage measurements) may be inverted using a multi-dimensional resistivity inversion process (e.g., including a 1D, 2D, 2.5D, and/or 3D inversion). The inversion results (e.g., spatial resistivity values) may then be evaluated to assemble a 3D resistivity volume about the wellbore in a pointset format. It will be appreciated that the pointset format may be thought of as a large text file including measured depth, resistivity, and x-, y-, and z-axis coordinates at every point in the 3D resistivity volume (e.g., distributed in a cylinder or cuboid about the wellbore).

Turning now to FIG. 3 a flow chart of an example method for extracting a 3D resistivity map in the Society of Exploration Geophysics (SEG-Y) format and for identifying a resistivity contrast as a boundary representing at least one horizon, interface, fluid contact, and/or fault in the formation is depicted. Deep reading electromagnetic logging measurements are inverted at 102, for example, using a 2D transverse inversion. The 2D inversion results are assembled into a 3D resistivity volume in pointset format at 104. A 3D resistivity volume in SEG-Y format is extracted from the 3D resistivity volume at 106 (e.g., the 3D resistivity volume in pointset formation may be transformed to the 3D resistivity map in SEG-Y format). The 3D resistivity map may be output as shown at 108 and may be further evaluated at 110 to generate a resistivity contrast map or volume, for example, via generating a binary 3D resistivity volume as described in more detail below. The resistivity contrast map may then be further evaluated at 112 to generate a 3D structural interpretation of the 3D resistivity map providing an indication of formation horizons, faults, interfaces, fluid contacts, and the like.

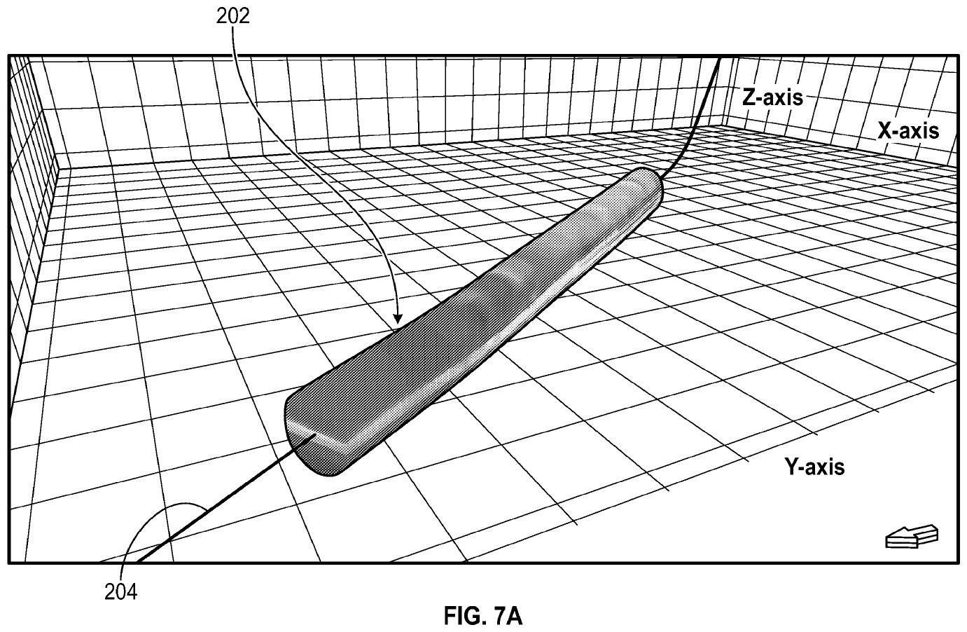

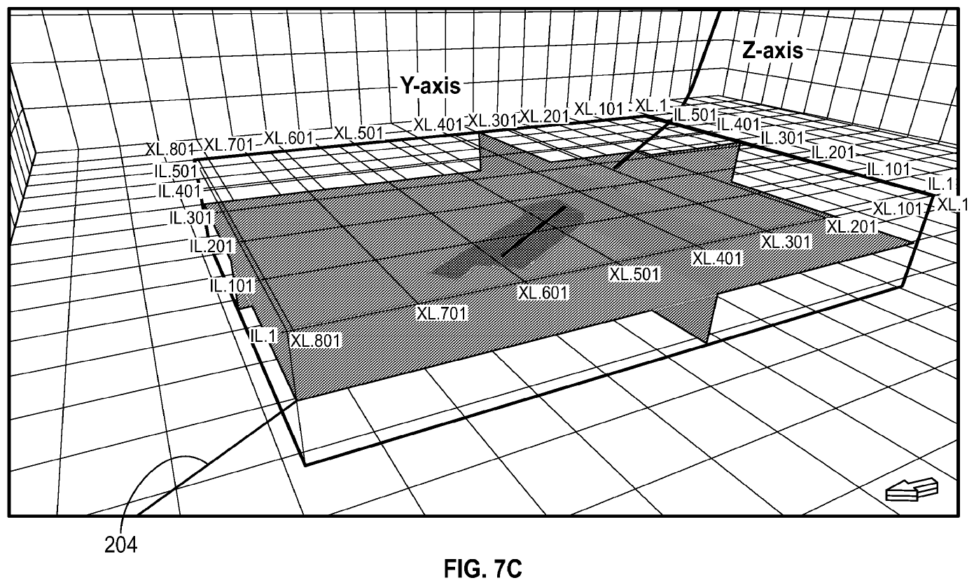

Turning now to FIG. 4, a flow chart of one example method 120 for generating a 3D resistivity map in SEG-Y format is depicted. A 3D resistivity volume in pointset format is obtained at 122, for example, via making and inverting ultradeep or deep reading electromagnetic measurements, for example, as described above with respect to FIG. 2. An empty SEG-Y grid may be defined at 124 that encompasses the obtained 3D resistivity volume. The empty SEG-Y grid may be superimposed on the pointset data (the 3D resistivity volume) at 126. Resistivity amplitudes along a single vertical trace may be extracted for each cell in the empty SEG-Y grid (e.g., at the center location of each cell) at 128 to obtain a preliminary resistivity map. As described in more detail below with respect to FIG. 6, the resistivity amplitudes may be extracted (or captured or computed) as a vertical trace (e.g., a trace in the z-direction) that extends downwards at each cell location (e.g., each center location) in the empty SEG-Y grid, for example, by compressing the pointset data along a vertical axis of each cell and organizing the compressed pointset data into a vertical trace. By each cell location it is meant each x-y-position in the empty SEG-Y grid.

It will be appreciated that the pointset data may not fully overlap the empty SEG-Y grid since the resistivity measurements in the 3D resistivity volume are distributed along the wellbore trajectory. Therefore, a projection (or superimposition) of the regularized empty SEG-Y grid on the nonregularized pointset data may cause smearing or distortion of the resistivity amplitudes along the edges of the grid (away from the wellbore trajectory). Method 120 may therefore further include discarding resistivity amplitudes that are outside a predetermined spatial volume of the wellbore trajectory at 130 to obtain the 3D resistivity volume in SEG-Y format.

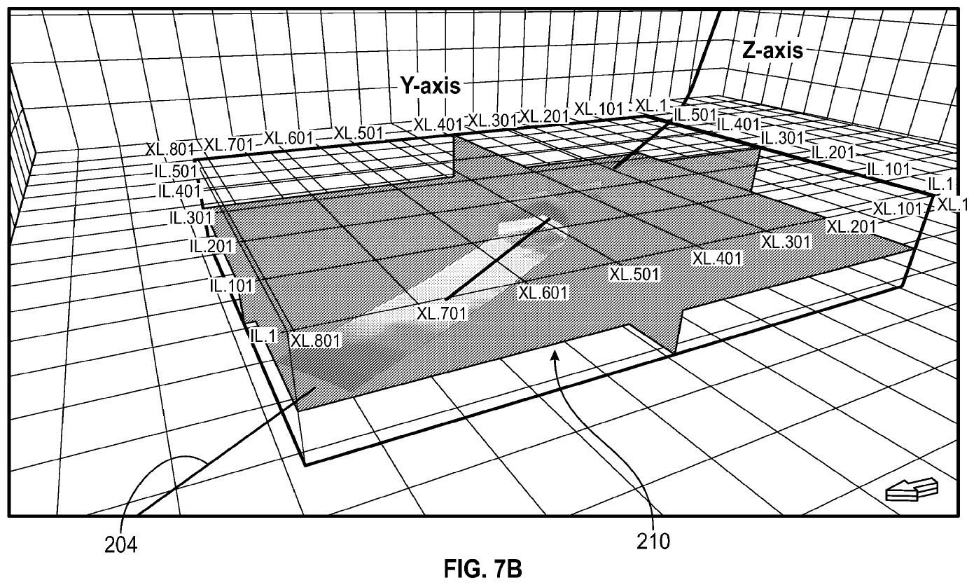

FIG. 5 depicts a flow chart of another example method 150 for generating a resistivity map in SEG-Y format and identifying at least one horizon in the formation. A 3D resistivity volume in pointset format may be obtained at 152, for example, via making and inverting ultradeep or deep reading electromagnetic measurements, for example, as described above with respect to FIG. 2. The 3D resistivity volume may be evaluated at 154 to determine the spatial extent of the data (e.g., by extracting spatial statistics from the pointset data). The spatial statistics may include, for example, minimum and maximum x, y, and z-axis spatial coordinates of the 3D resistivity volume. An empty SEG-Y grid may then be defined at 156 that encompasses the obtained 3D resistivity volume. For example, the empty SEG-Y grid may be defined by dividing differences between maximum and minimum x, y, and z-axis spatial coordinates by a predetermined or user selected grid spacing (such as 0.1, 0.5 or 1 meter). The empty SEG-Y grid may be superimposed on the pointset data at 158. Resistivity amplitudes along a single vertical trace may be extracted for each cell in the empty SEG-Y grid (e.g., at the center location of each cell) at 160 to obtain a preliminary resistivity map, for example, as described in more detail below with respect to FIG. 6.

As noted above, superimposing a regularized empty SEG-Y grid on the nonregularized pointset data may cause smearing or distortion of the resistivity amplitudes along the edges of the grid (away from the wellbore). To address this difficulty, certain ones of the resistivity amplitudes may be discarded, for example, those amplitudes that are located too far from the wellbore (e.g., greater than a threshold distance from the wellbore). In one embodiment, the wellbore trajectory (also referred to as a well path) may be obtained at 162, for example, from survey measurements (e.g., static and/or dynamic inclination and azimuth measurements made during the drilling operation). A detection volume (or surface) may be computed about the well trajectory at 164, for example, from the detection limit of the deep reading resistivity measurements. The detection volume (or surface) may be a cylindrical volume or surface, for example, about the well trajectory having a radius equal to the detection limit (or some predetermined fraction or multiple of the detection limit). As noted above with respect to FIG. 2, the detection limit may be related to (e.g., a fraction or multiple of) one of the transmitter-receiver spacings in the deep reading resistivity electromagnetic logging tool. Resistivity amplitudes that are located outside the detection volume may be discarded at 166 to obtain the 3D resistivity map in SEG-Y format. For example, the detection volume may be superimposed with the preliminary resistivity map. Amplitudes outside the detection volume may be discarded while amplitudes inside the detection volume may be retained.

With continued reference to FIG. 5, method 150 may further include converting the 3D resistivity map in SEG-Y format to a 3D contrast map, for example, to a 3D binary volume at 168. For example, a predetermined or user defined resistivity threshold may be applied to the 3D resistivity map. Cells having a resistivity value greater than the threshold may be assigned a first, high resistivity value (e.g., 100 ohm m) while cells having a resistivity value less than the threshold may be assigned a second, low resistivity value (e.g., 1 ohm m). The resulting 3D binary volume may therefore indicate first and second, high resistivity and low resistivity volumes in the 3D resistivity map as well as interfaces or surfaces therebetween. It will be appreciated that the disclosed embodiments are not limited to conversion of the 3D SEG-Y resistivity map to only a single binary volume. In other embodiments, the map may be converted, for example, to a tertiary or quaternary volume by applying first and second or first, second, and third resistivity cutoffs to the map to define three or more distinct resistivity volumes and the corresponding interfaces therebetween. Moreover, in other embodiments the 3D resistivity map may be converted to multiple distinct binary volumes by repeating the conversion at 168 at multiple distinct threshold resistivity values (e.g., to generate first, second, and third 3D binary volumes using corresponding first, second, and third threshold values).

With further reference to FIG. 5, the binary (or tertiary or quaternary) volume may then be further evaluated at 170 to identify and characterize the interfaces or boundaries between the distinct resistivity volumes. For example, the binary volume(s) may be further evaluated using a 3D auto-tracking tool to interpret a horizon or horizons indicated by the interfaces. The 3D binary volume may be still further evaluated at 170 to compute a geological volume of each region (e.g., to compute the geological volume of the high resistivity and possibly oil bearing volume) in the binary volume.

FIG. 6 depicts a flow chart of one example method 180 for extracting resistivity 12 amplitudes from the pointset data at 128 of FIG. 4 or 160 of FIG. 5 and thereby transforming the resistivity data from a discrete space representation in x-, y-, and z-axes to vertical amplitude trace representation in having varying (e.g., continuously varying) amplitude values for given x- and y-axis position (referred to herein as the SEG-Y format). The method 180 includes defining multiple headers at 182 that include auxiliary set information such as sampling rate, trace size, trace length, X & Y co-ordinates etc. This auxiliary set information may be obtained from the empty SEG-Y grid defined at 124 of FIGS. 4 and 156 of FIG. 5. The pointset data is then compressed/transformed into a more efficient format (binary in one example embodiment) at 184. The pointset data may be fed into a compression algorithm by defining sliding windows across different whole columns (e.g., at each cell location) of the pointset data. In one example embodiment, a window length of at least 10% of the total trace length is used. The window may slide by about 50% of the window size. The compression algorithm may be configured to perform a dimensionality reduction using data transformation from one domain to another such that the maximum amount of information (variance) is conserved, and the rest of the information is ignored.

With continued reference to FIG. 6, the compressed data generated in 184 is then organized into a vertical trace at 186 for each cell location in the empty SEG-Y grid. A record is kept of the compression process and may be used for future processing of the data back to the original pointset format. A sinc interpolation may also be applied to the data to provide the visual trace (e.g., to provide a smooth or continuous trace). Each trace may then be stored and/or output in SEG-Y format at 188 including the relevant information used to generate the trace, for example, including extended binary coded decimal interchange code (EBCDIC) headers, binary headers, and trace headers. It will be appreciated that the stored (or output) product may have an increased size in comparison to the original pointset data owing to the additional compression information stored along with the data.

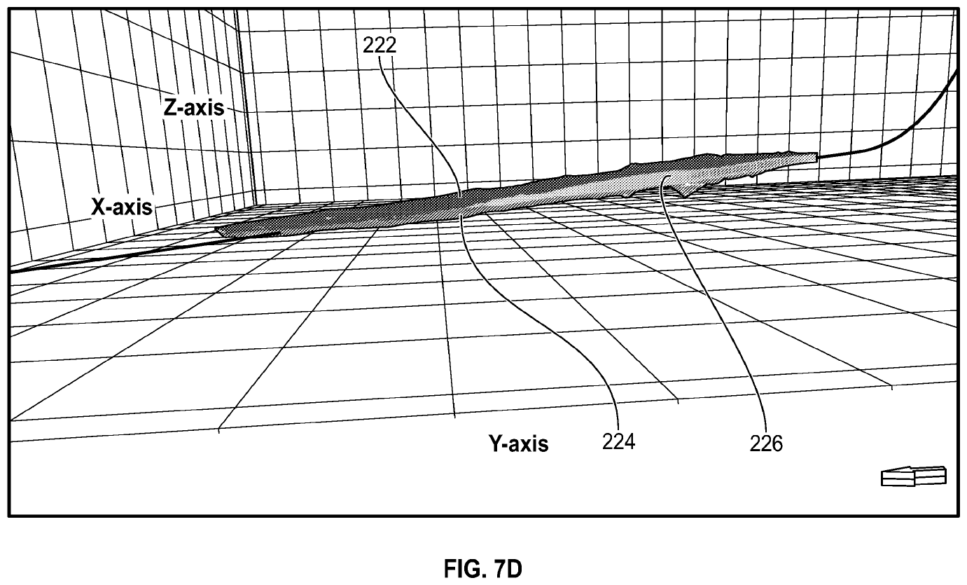

Turning now to FIGS. 7A, 7B, 7C, and 7D (collectively FIG. 7) an example implementation of method 150 is depicted. FIG. 7A depicts a 3D resistivity volume in pointset format at 202. In the depicted example, the 3D resistivity volume includes a 3D array of formation resistivity values (shown in greyscale) distributed about the wellbore 204. Note that the 3D resistivity volume is shown in three-dimensional space in which the z-axis represents the total vertical depth (downward from the surface) and the x- and y-axes represent northerly and easterly directions. FIG. 7B depicts a 3D resistivity map in SEG-Y format 210 extracted from the 3D resistivity volume shown on FIG. 7A. In the depicted example, the 3D resistivity map is shown as a cuboid in the above described three-dimensional space. FIG. 7C depicts a binary volume obtained by applying a resistivity threshold to the 3D resistivity map shown on FIG. 7B. Cells having resistivity values greater than the threshold value are shown as dark grey at 212. Note that region 212 may represent a potential reservoir. Cells having resistivity values less than the threshold value as well as cells having discarded resistivity values are shown as light grey at 214. FIG. 7D depicts a horizon extracted from the binary volume shown on FIG. 7C in which the upper and lower interfaces of the potential reservoir are shown at 222 and 224. A 3D resistivity map in SEG-Y format of the potential reservoir is shown at 226 between the upper and lower interfaces 222, 224.

It will be understood that the present disclosure includes numerous embodiments. These embodiments include, but are not limited to, the following embodiments.

In a first embodiment a method for generating a three-dimensional (3D) resistivity map of a subterranean formation in a Society for Geological Exploration (SEG-Y) format includes obtaining a 3D resistivity volume in pointset format, the 3D resistivity volume including a three-dimensional array of formation resistivity values about a subterranean wellbore; defining an empty SEG-Y grid that encompasses the obtained 3D resistivity volume; superimposing the empty SEG-Y grid on the obtained 3D resistivity volume; extracting resistivity amplitudes from the 3D resistivity volume along a single vertical trace for each cell in the empty SEG-Y grid to generate a preliminary resistivity map; and discarding unwanted ones of the extracted resistivity amplitudes in the preliminary resistivity map to generate the 3D resistivity map in the SEG-Y format.

A second embodiment may include the first embodiment, wherein the obtaining the 3D resistivity volume in the pointset format comprises: making deep reading electromagnetic measurements in the subterranean wellbore; inverting the deep reading electromagnetic measurements using a multi-dimensional resistivity inversion algorithm to inverted resistivity values; and assembling the 3D resistivity volume in the pointset format from the inverted resistivity values.

A third embodiment may include the second embodiment, wherein the making the deep reading electromagnetic measurements in the wellbore comprises: rotating a deep reading electromagnetic logging tool in the subterranean wellbore; transmitting electromagnetic energy into the subterranean wellbore while rotating using a transmitter on the deep reading electromagnetic logging tool; and receiving the transmitted electromatic energy at a receiver on the deep reading electromagnetic logging tool, wherein the receiver is spaced apart from the transmitter by at least 10 meters.

A fourth embodiment may include any one of the first through third embodiments, wherein the defining the empty SEG-Y grid comprises: extracting maximum and minimum x, y, and z-axis spatial coordinates from the 3D resistivity volume; and dividing a difference between the maximum and minimum x, y, and z-axis spatial coordinates by a predetermined or user selected grid spacing.

A fifth embodiment may include any one of the first through fourth embodiments, wherein the extracting the resistivity amplitudes along the single vertical trace for each cell in the empty SEG-Y grid comprises: compressing the pointset data along a vertical axis of the cell; and organizing the compressed pointset data into the single vertical trace.

A sixth embodiment may include any one of the first through fifth embodiments, wherein the discarding the resistivity amplitudes comprises discarding the ones of the extracted resistivity amplitudes that are located greater than a predetermined distance from the subterranean wellbore.

A seventh embodiment may include any one of the first through sixth embodiments, wherein the discarding the resistivity amplitudes comprises: obtaining a trajectory of the subterranean wellbore; determining a detection limit of a deep reading electromagnetic resistivity tool; computing a detection volume about the subterranean wellbore from the trajectory and the detection limit; and discarding the resistivity amplitudes that are outside of the detection volume.

An eighth embodiment may include any one of the first through seventh embodiments, further comprising: applying a first resistivity threshold to the 3D resistivity map in SEG-Y format to generate a binary resistivity volume in which locations having a resistivity value greater than the first resistivity threshold are assigned a first high resistivity value and locations having a resistivity value less than the first resistivity threshold are assigned a second low resistivity value.

A ninth embodiment may include the eighth embodiment, further comprising: evaluating high and low resistivity volumes in the binary resistivity volume to characterize at least one interface between the high and low resistivity volumes.

A tenth embodiment may include the ninth embodiment, further comprising repeating the applying and the evaluating at a second resistivity threshold, wherein the second resistivity threshold is different than the first resistivity threshold.

In an eleventh embodiment, a system for generating a three-dimensional (3D) resistivity map of a subterranean formation in Society for Geological Exploration (SEG-Y) includes a deep reading electromagnetic logging tool configured to make measurements in a wellbore penetrating the subterranean formation; and at least one computer processor configured to: apply a multi-dimensional inversion algorithm to the measurements to generate a 3D resistivity volume in pointset format; define an empty SEG-Y grid that encompasses the 3D resistivity volume; superimpose the empty SEG-Y grid on the 3D resistivity volume; extract resistivity amplitudes from the 3D resistivity volume along a single vertical trace for each cell in the empty SEG-Y grid to generate a preliminary resistivity map; and discard unwanted ones of the extracted resistivity amplitudes in the preliminary resistivity map to generate the 3D resistivity map in the SEG-Y format.

A twelfth embodiment may include the eleventh embodiment, wherein the define the empty SEG-Y grid comprises: extract maximum and minimum x, y, and z-axis spatial coordinates from the 3D resistivity volume; and divide a difference between the maximum and minimum x, y, and z-axis spatial coordinates by a predetermined or user selected grid spacing.

A thirteenth embodiment may include any one of the eleventh through twelfth embodiments, wherein the extract the resistivity amplitudes along the single vertical trace for each cell in the empty SEG-Y grid comprises: compress the pointset data along a vertical axis of the cell; and organize the compressed pointset data into the single vertical trace.

A fourteenth embodiment may include any one of the eleventh through thirteenth embodiments, wherein the discard the resistivity amplitudes comprises: obtain a trajectory of the wellbore; determine a detection limit of the deep reading electromagnetic resistivity tool; compute a detection volume about the wellbore from the trajectory and the detection limit; and discard the resistivity amplitudes that are outside of the detection volume.

A fifteenth embodiment may include any one of the eleventh through fourteenth embodiments, wherein the at least one processor is further configured to: apply a resistivity threshold to the 3D resistivity map in SEG-Y format to generate a binary resistivity volume in which locations having a resistivity value greater than the resistivity threshold are assigned a first high resistivity value and locations having a resistivity value less than the resistivity threshold are assigned a second low resistivity value; and evaluate high and low resistivity volumes in the binary resistivity volume to characterize at least one interface between the high and low resistivity volumes.

In a sixteenth embodiment, a method for identifying an interface between a high resistivity volume and a low resistivity volume in a subterranean formation includes obtaining a three-dimensional (3D) resistivity volume in pointset format, the 3D resistivity volume including a three-dimensional array of formation resistivity values about a subterranean wellbore; transforming the 3D resistivity volume in the pointset format to a 3D resistivity map in Society for Geological Exploration (SEG-Y) format; applying a first resistivity threshold to the 3D resistivity map in the SEG-Y format to generate a binary resistivity volume in which cells in the 3D resistivity map having a resistivity value greater than the first resistivity threshold are assigned a first high resistivity value and cells having a resistivity value less than the first resistivity threshold are assigned a second low resistivity value; and evaluating the binary resistivity volume to identify the interface between the high resistivity volume and the low resistivity volume.

A seventeenth embodiment may include the sixteenth embodiment further comprising: repeating the applying and the evaluating for a second resistivity threshold, wherein the second resistivity threshold is different than the first resistivity threshold.

An eighteenth embodiment may include any one of the sixteenth through seventeenth embodiments, wherein the obtaining the 3D resistivity volume in the pointset format comprises: making deep reading electromagnetic measurements in the subterranean wellbore; inverting the deep reading electromagnetic measurements using a multi-dimensional resistivity inversion algorithm to obtain a resistivity inversion; and assembling the 3D resistivity volume in pointset format from the resistivity inversion.

A nineteenth embodiment may include any one of the sixteenth through eighteenth embodiments, wherein the converting the 3D resistivity volume comprises: defining an empty SEG-Y grid that encompasses the obtained 3D resistivity volume; superimposing the empty SEG-Y grid on the obtained 3D resistivity volume; extracting resistivity amplitudes from the 3D resistivity volume along a single vertical trace for each cell in the empty SEG-Y grid to generate a preliminary resistivity map; and discarding unwanted ones of the extracted resistivity amplitudes in the preliminary resistivity map to generate the 3D resistivity map in SEG-Y format.

A twentieth embodiment may include the nineteenth embodiment, wherein: the extracting the resistivity amplitudes comprises compressing the pointset data along a vertical axis of the cell; and organizing the compressed pointset data into the single vertical trace for each of the cells; and the discarding comprises obtaining a trajectory of the subterranean wellbore; determining a detection limit of a deep reading electromagnetic resistivity tool; computing a detection volume about the subterranean wellbore from the trajectory and the detection limit; and discarding the resistivity amplitudes that are outside of the detection volume.

As described above, the disclosed embodiments include methods and systems for transforming resistivity data from a discrete space pointset representation to an SEG-Y format. It will be appreciated that the disclosed embodiments may further encompass a 3D resistivity map. For example, the disclosed embodiments may include a 3D resistivity may that is made up of a 2D array or grid of resistivity amplitude traces in which the amplitude traces define the resistivity values along a vertical dimension orthogonal to the 2D array.

Although three-dimensional resistivity reservoir mapping has been described in detail, it should be understood that various changes, substitutions and alternations can be made herein without departing from the spirit and scope of the disclosure as defined by the appended claims.

1. A method for generating a three-dimensional (3D) resistivity map of a subterranean formation in a Society for Geological Exploration (SEG-Y) format, the method comprising:
obtaining a 3D resistivity volume in pointset format, the 3D resistivity volume including a three-dimensional array of formation resistivity values about a subterranean wellbore;
defining an empty SEG-Y grid that encompasses the obtained 3D resistivity volume, wherein the defining comprises:
extracting maximum and minimum x, y, and z-axis spatial coordinates from the 3D resistivity volume; and
dividing a difference between the maximum and minimum x, y, and z-axis spatial coordinates by a predetermined or user selected grid spacing;
superimposing the empty SEG-Y grid on the obtained 3D resistivity volume;
extracting resistivity amplitudes from the 3D resistivity volume along a single vertical trace for each cell in the empty SEG-Y grid to generate a preliminary resistivity map; and
discarding unwanted ones of the extracted resistivity amplitudes in the preliminary resistivity map to generate the 3D resistivity map in the SEG-Y format.

2. The method of claim 1, wherein the obtaining the 3D resistivity volume in the pointset format comprises:
making deep reading electromagnetic measurements in the subterranean wellbore;
inverting the deep reading electromagnetic measurements using a multi-dimensional resistivity inversion algorithm to inverted resistivity values; and
assembling the 3D resistivity volume in the pointset format from the inverted resistivity values.

3. The method of claim 2, wherein the making the deep reading electromagnetic measurements in the wellbore comprises:
rotating a deep reading electromagnetic logging tool in the subterranean wellbore;
transmitting electromagnetic energy into the subterranean wellbore while rotating using a transmitter on the deep reading electromagnetic logging tool; and
receiving the transmitted electromatic energy at a receiver on the deep reading electromagnetic logging tool, wherein the receiver is spaced apart from the transmitter by at least 10 meters.

4. (canceled)

5. The method of claim 1, wherein the extracting the resistivity amplitudes along the single vertical trace for each cell in the empty SEG-Y grid comprises:
compressing the pointset data along a vertical axis of the cell; and
organizing the compressed pointset data into the single vertical trace.

6. The method of claim 1, wherein the discarding the resistivity amplitudes comprises discarding the ones of the extracted resistivity amplitudes that are located greater than a predetermined distance from the subterranean wellbore.

7. The method of claim 1, wherein the discarding the resistivity amplitudes comprises:
obtaining a trajectory of the subterranean wellbore;
determining a detection limit of a deep reading electromagnetic resistivity tool;
computing a detection volume about the subterranean wellbore from the trajectory and the detection limit; and
discarding the resistivity amplitudes that are outside of the detection volume.

8. The method of claim 1, further comprising:
applying a first resistivity threshold to the 3D resistivity map in SEG-Y format to generate a binary resistivity volume in which locations having a resistivity value greater than the first resistivity threshold are assigned a first high resistivity value and locations having a resistivity value less than the first resistivity threshold are assigned a second low resistivity value.

9. The method of claim 8, further comprising:
evaluating high and low resistivity volumes in the binary resistivity volume to characterize at least one interface between the high and low resistivity volumes.

10. The method of claim 9, further comprising repeating the applying and the evaluating at a second resistivity threshold, wherein the second resistivity threshold is different than the first resistivity threshold.

11. A system for generating a three-dimensional (3D) resistivity map of a subterranean formation in Society for Geological Exploration (SEG-Y) format, the system comprising:
a deep reading electromagnetic logging tool configured to make measurements in a wellbore penetrating the subterranean formation; and
at least one computer processor configured to:
apply a multi-dimensional inversion algorithm to the measurements to generate a 3D resistivity volume in pointset format;
define an empty SEG-Y grid that encompasses the 3D resistivity volume, wherein the define comprises:
extract maximum and minimum x, y, and z-axis spatial coordinates from the 3D resistivity volume; and
divide a difference between the maximum and minimum x, y, and z-axis spatial coordinates by a predetermined or user selected grid spacing;
superimpose the empty SEG-Y grid on the 3D resistivity volume;
extract resistivity amplitudes from the 3D resistivity volume along a single vertical trace for each cell in the empty SEG-Y grid to generate a preliminary resistivity map; and
discard unwanted ones of the extracted resistivity amplitudes in the preliminary resistivity map to generate the 3D resistivity map in the SEG-Y format.

12. (canceled)

13. The system of claim 11, wherein the extract the resistivity amplitudes along the single vertical trace for each cell in the empty SEG-Y grid comprises:
compress the pointset data along a vertical axis of the cell; and
organize the compressed pointset data into the single vertical trace.

14. The system of claim 11, wherein the discard the resistivity amplitudes comprises:
obtain a trajectory of the wellbore;
determine a detection limit of the deep reading electromagnetic resistivity tool;
compute a detection volume about the wellbore from the trajectory and the detection limit; and
discard the resistivity amplitudes that are outside of the detection volume.

15. The system of claim 11, wherein the at least one processor is further configured to:
apply a resistivity threshold to the 3D resistivity map in SEG-Y format to generate a binary resistivity volume in which locations having a resistivity value greater than the resistivity threshold are assigned a first high resistivity value and locations having a resistivity value less than the resistivity threshold are assigned a second low resistivity value; and
evaluate high and low resistivity volumes in the binary resistivity volume to characterize at least one interface between the high and low resistivity volumes.

16. A method for identifying an interface between a high resistivity volume and a low resistivity volume in a subterranean formation, the method comprising:
obtaining a three-dimensional (3D) resistivity volume in pointset format, the 3D resistivity volume including a three-dimensional array of formation resistivity values about a subterranean wellbore;
transforming the 3D resistivity volume in the pointset format to a 3D resistivity map in Society for Geological Exploration (SEG-Y) format;
applying a first resistivity threshold to the 3D resistivity map in the SEG-Y format to generate a binary resistivity volume in which cells in the 3D resistivity map having a resistivity value greater than the first resistivity threshold are assigned a first high resistivity value and cells having a resistivity value less than the first resistivity threshold are assigned a second low resistivity value; and
evaluating the binary resistivity volume to identify the interface between the high resistivity volume and the low resistivity volume.

17. The method of claim 16, further comprising:
repeating the applying and the evaluating for a second resistivity threshold, wherein the second resistivity threshold is different than the first resistivity threshold.

18. The method of claim 16, wherein the obtaining the 3D resistivity volume in the pointset format comprises:
making deep reading electromagnetic measurements in the subterranean wellbore;
inverting the deep reading electromagnetic measurements using a multi-dimensional resistivity inversion algorithm to obtain a resistivity inversion; and
assembling the 3D resistivity volume in pointset format from the resistivity inversion.

19. The method of claim 16, wherein the converting the 3D resistivity volume comprises:
defining an empty SEG-Y grid that encompasses the obtained 3D resistivity volume;
superimposing the empty SEG-Y grid on the obtained 3D resistivity volume;
extracting resistivity amplitudes from the 3D resistivity volume along a single vertical trace for each cell in the empty SEG-Y grid to generate a preliminary resistivity map; and
discarding unwanted ones of the extracted resistivity amplitudes in the preliminary resistivity map to generate the 3D resistivity map in SEG-Y format.

20. The method of claim 19, wherein:
the extracting the resistivity amplitudes comprises compressing the pointset data along a vertical axis of the cell; and organizing the compressed pointset data into the single vertical trace for each of the cells; and
the discarding comprises obtaining a trajectory of the subterranean wellbore; determining a detection limit of a deep reading electromagnetic resistivity tool; computing a detection volume about the subterranean wellbore from the trajectory and the detection limit; and discarding the resistivity amplitudes that are outside of the detection volume.
